(19) United States
(12) Patent Application Publication
(10) Pub. No.: US 2023/0296039 A1
(43) Pub. Date: Sep. 21, 2023

(54) Machine Housing Ventilator

(71) Applicant: Bayerische Motoren Werke Aktiengesellschaft, Muenchen (DE)

(72) Inventors: Martin HUBER, Muenchen (DE); Hakan SAHIN, Muenchen (DE)

(21) Appl. No.: 18/017,758

(22) PCT Filed: Aug. 20, 2021
(86) PCT No.: PCT/EP2021/073099

§ 371 Date: Jan. 24, 2023

(30) Foreign Application Priority Data
Sep. 11, 2020 (DE) 10 2020 123 692.1

(51) Int. Cl. F01M 13/04; F16H 57/027

(52) U.S. Cl. CPC F01M 13/04; F16H 57/027; F01M 2013/0461; F01M 2013/0433

(57) ABSTRACT

A machine housing ventilator has an oil separator device which has a media inlet and a media outlet. The media outlet is covered by an air-permeable ventilating device or is fluidically connected thereto. The oil separator device has an oil separator housing in which the media inlet is provided. A gaseous medium can enter the oil separator housing through the media inlet in a planned manner and can escape through the oil separator device and through the ventilating device into the environment surrounding the machine housing ventilator. The oil separator housing has a labyrinth ventilator device for deflecting medium flowing through the machine housing ventilator, and an intended rectilinear flow direction through the oil separator housing, a so-called ventilation direction, is defined. The ventilation direction runs in the direction from the media inlet to the media outlet. The labyrinth ventilator device is at least partially surrounded, in a circumferential direction relative to the ventilation direction, by the oil separator housing and is formed as a separate component from the housing.

### BACKGROUND AND SUMMARY

The invention relates to a machine housing ventilator and to a motor vehicle gearbox having a ventilator of this kind.

A ventilation mechanism for a gearbox housing is known from the prior art, in particular from DE 10 2015 002 320 A1.

The invention is explained below in connection with a gearbox housing for a motor vehicle; this should not, however, be understood as limiting the invention to an application of this kind. Insofar as in the gearbox housing the gears accommodated therein are lubricated by means of dip lubrication, foam or aerosols can be created. Furthermore, a gearbox housing of this kind has a machine housing or gearbox ventilator, which particularly allows an exchange of air between the environment surrounding the gearbox housing and the interior of the gearbox. Due to the fact of the foam or aerosol formation in this interior, the lubricating foam or aerosol can escape from the interior into the environment surrounding the gearbox housing. This results in lubricant from the gearbox interior being introduced into the environment surrounding the gearbox housing, and is undesirable. This phenomenon causes contamination of the gearbox housing concerned, for example of an axle drive in a motor vehicle, and can result in a leak being suspected at the gearbox housing which does not actually exist.

A problem addressed by the invention is that of providing a machine housing ventilator and a motor vehicle gearbox having a ventilator of this kind, which have improved operating properties. This problem is solved by a machine housing ventilator according to the independent claim, and by a motor vehicle gearbox having a ventilator of this kind, preferable developments of the invention are the subject matter of the dependent patent claims in each case.

Within the meaning of the invention, a machine housing ventilator is understood to mean a mechanism for allowing there to be pressure compensation and, in particular, a media exchange between an interior of a machine housing and an environment surrounding the machine housing. Furthermore, the machine housing ventilator is set up in such a manner that it allows a free passage from this interior into this surrounding environment, so that an imaginary flow from an interior space of a machine housing through the machine housing ventilator into a surrounding environment is allowed, without the medium passing through a membrane. In particular, a membrane of this kind frequently has the disadvantage that wetting with a lubricant can lead to a loss or reduction in its functional capability.

The machine housing ventilator furthermore has an oil separator mechanism which has a media inlet and a media outlet, wherein this oil separator mechanism is further set up to free an aerosol or a foam, which flows through the machine housing ventilator for pressure compensation, of liquid or liquid droplets or at least to reduce the proportion thereof. The media outlet of the oil separator housing is covered by an air-permeable ventilation mechanism or fluidically connected thereto, wherein this ventilator mechanism allows a free passage from the interior into the environment. The oil separator mechanism has an oil separator housing in which the media inlet is arranged and the media inlet allows a gaseous medium from an interior of a machine housing to enter the oil separator housing as planned. This medium can further escape through the oil separator mechanism and through the ventilator mechanism into the environment surrounding the machine housing ventilator.

In order to remove liquid from the medium flowing through the machine housing ventilator, the oil separator housing has, in particular, a labyrinth ventilator mechanism for deflecting this medium. An imaginary rectilinear flow direction through the oil separator housing, the so-called ventilation direction, is furthermore defined. In relation to a cylindrical oil separator housing, the ventilation direction can be regarded as a cylinder axis, with the flow direction being from the media inlet to the media outlet.

It is further provided that the machine housing ventilator has a labyrinth ventilator mechanism which is arranged in the oil separator housing, so that the labyrinth ventilator mechanism is surrounded by the oil separator housing in a circumferential direction, particularly in relation to the ventilation direction. Furthermore, the labyrinth ventilator mechanism is configured as a separate component in relation to the oil separator housing. The oil separator housing is preferably formed from a metal material or comprises a material of this kind, at least as a component, and, more preferably, the labyrinth ventilator mechanism is formed from a plastic or comprises a material of this kind, at least as a component. A configuration of this kind makes it possible, in particular, to insert the labyrinth ventilator mechanism into an oil separator housing, in particular a good adjustment to the spatial conditions is thereby made possible.

In a preferred embodiment, the labyrinth ventilator mechanism comprises a first and at least a second deflector wall, which are set up to prevent a rectilinear flow through the oil separator housing. More preferably, these deflector walls are arranged spaced apart from one another in the oil separator housing and they are preferably arranged, at least substantially, parallel to one another. More preferably, the at least two deflector walls are connected to one another by means of a center web and spaced apart from one another by this web. This arrangement means, in particular, that the first and at least a second deflector wall are arranged downstream of the media inlet and upstream of the media outlet, relative to the ventilation direction, in the oil separator housing.

The first deflector wall in this case is set up in such a manner that it closes off the oil separator housing except for at least a first region which can be flowed through, the so-called first flow-through region. For closing off, the first deflector wall covers a particular region of the cross section of the oil separator housing on which the deflector wall is arranged, and furthermore the total of the region which is covered and can be flowed through produces the full cross-sectional area of the oil separator housing at the place at which the first deflector wall is arranged. The second deflector wall is more preferably arranged in the oil separator housing in such a manner that it closes off the oil separator housing except for at least a second region which can be flowed through, the so-called second flow-through region. For closing off, the second deflector wall covers a particular region of the cross section of the oil separator housing on which the deflector wall is arranged, and furthermore the total of the region which is covered and can be flowed through produces the full cross-sectional area of the oil separator housing at the place at which the second deflector wall is arranged.

The first deflector wall preferably constricts the area that can be flowed through in the oil separator housing to the first flow-through region, which accounts for 40%, or less, of the total cross-sectional area of the oil separator housing, relative to the place at which the first deflector wall is arranged. The second deflector wall preferably constricts the area that can be flowed through in the oil separator housing to the second flow-through region, which accounts for 40%, or less, of the total cross-sectional area of the oil separator housing, relative to the place at which the second deflector wall is arranged. More preferably, there is a constriction to less than 20%, and more preferably to less than 10%, in at least one of the deflector walls, or in multiple, or in all deflector walls.

In particular, with an at least duplicate (first deflector wall, at least a second deflector wall) constriction of this kind of the flow-through regions to less than 50%, preferably less than 40%, of the total area that can be flowed through in theory in the oil separator housing, a high degree of separation of liquid from the medium flowing through the machine housing ventilator is made possible.

In a preferred embodiment, the first and at least a second deflector wall are arranged in the oil separator housing in such a manner that the first and the second flow-through region are turned in relation to one another or pushed against one another. In particular, at least two flow-through regions are pushed against one another, in such a manner that a rectilinear flow in the ventilation direction through the oil separator housing is prevented by these at least two deflector walls. In other words, a deflection of medium flowing through the oil separator housing is achieved by means of the two deflector walls and the two flow-through regions arranged therein. Tests have shown that through a deflection of a media flow through the oil separator housing, the functional reliability of the machine housing ventilator can be improved.

In a preferred embodiment, the labyrinth ventilator mechanism has an end wall which comprises at least an outlet region which can be freely flowed through, or else forms an outlet region of this kind along with the oil separator housing. The oil separator housing also has a limit stop which is preferably in contact through the end wall of the labyrinth mechanism, preferably in the axial direction, and in particular makes contact with the end wall of the oil separator housing where the media outlet is not arranged. In particular, this outlet region which can be freely flowed through can be understood to be the media outlet of the oil separator housing. Particularly by means of the proposed embodiment, a reliable positioning of the labyrinth ventilator mechanism in the oil separator housing is made possible.

Furthermore, a motor vehicle gearbox is proposed which has at least one machine housing ventilator which is designed according to one of the preceding claims. A machine housing ventilator of this kind allows, in particular, the retention of fluid in the interior or the motor vehicle gearbox and therefore makes it possible for there to be pressure compensation between the interior of the motor vehicle gearbox and the environment surrounding the motor vehicle.

Individual features and an embodiment of the invention are explained in greater detail below with the help of the figures; combinations of features other than those depicted are also possible in principle in this case.

### BRIEF DESCRIPTION OF THE DRAWINGS

FIG. 1 is a perspective sectional representation through a machine housing ventilator arranged on a motor vehicle gearbox; and

FIG. 2 is a perspective representation of a labyrinth ventilator mechanism for use in a hollow cylindrical oil separator housing.

### DETAILED DESCRIPTION OF THE DRAWINGS

In the case of machine housing ventilators known in the art, in particular those which allow barrier-free pressure compensation, in other words, pressure compensation without passing through a membrane, this ventilator may be made up of a ventilator lower part used in the gearbox housing, preferably glued in, which is made of a metal material, preferably an aluminum material, and a ventilating mechanism, preferably a ventilator cap. Labyrinth structures, such as those proposed by means of the labyrinth mechanism as a separate component, offer functional advantages compared with this, which prevent, or at least reduce, the escape of oil and oil foam.

It is furthermore known in the art that the ventilator cap has small bores or recesses, through which an excess pressure existing in the machine housing interior can escape therefrom by means of the machine housing ventilator, and the medium flowing out through the ventilator cap in this case carries small amounts of oil and oil foam with it, this medium can therefore be perceived as an aerosol and transport this oil, or oil foam, into the environment in solutions known in the art.

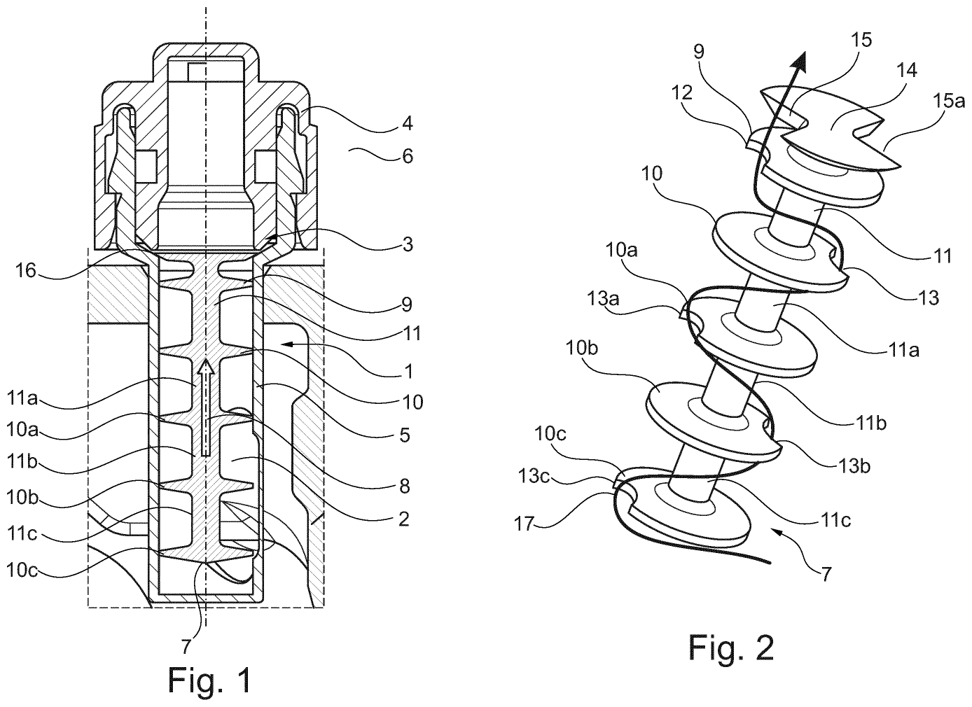

By contrast, the solution depicted in FIG. 1 is provided, in which an oil separator mechanism 1 is used with a labyrinth mechanism 7. In the case of a retrofitting solution, the labyrinth mechanism 7 is received in the ventilator lower part used as the oil separator housing 5. The ventilator lower part, or oil separator housing 5, is devised in such a way in many existing machine housing ventilators that it can be further used without any additional change with a labyrinth mechanism 7, in addition to which a combination of a labyrinth mechanism 7 with an oil separator housing 5 adapted thereto, or a ventilator mechanism 4 with a labyrinth mechanism 7, can be used as a one-part solution. The proposed design means that the oil and the oil foam are retained in the oil separator housing 5 during the pressure compensation and only the air from the interior of the machine housing, for example a gearbox housing, escapes into the surrounding environment 6. In this case, the medium which is still contaminated with oil escapes from the machine housing via the media inlet 2 into the oil separator housing 5 and flows through this basically in the ventilation direction 8. Through the labyrinth mechanism 7 arranged in the oil separator housing, the media flow is deflected multiple times, however, according to the media flow 17 (FIG. 2).

A basic consideration, in the case of the machine housing ventilator shown with the oil separator mechanism 1, is that the labyrinth mechanism 7 in the oil separator housing 5 provided, results in oil foam, oil mist and oil spray being retained at different stages. Therefore, via the media outlet 3, which is formed by the outlet region 15 in the end wall 14 in conjunction with the oil separator housing 5, only air escapes via the ventilator mechanism 4. As shown, multiple outlet regions 15, 15a can be arranged in the end wall 14. The oil separation in the ventilator housing 5 is achieved by means of the selectively deflected media flow 17 and the deflector walls 9, 10a, 10b, 10c.

The oil foam or else the aerosol, which occurs in the interior of a machine housing being ventilated, is explained based on the example of an axle drive for a motor vehicle with immersion or injection lubrication, in this axle drive through the swirling of the oil when the gears move, wherein the oil is required for lubrication. In order to remove the thermally induced excess pressure from the gearbox, ventilation with small bores or recesses is used in the environment 6 surrounding the axle gearbox. In this case, it may be that small quantities of oil also get into this environment 6. In this case, the labyrinth mechanism 7, in conjunction with the oil separator housing 5, retains the oil contained in the aerosol before it reaches the ventilator mechanism 4.

Through a multi-stage design of the labyrinth mechanism 7, in which the first deflector wall 9 with the first flow-through region 12 is spaced apart from the second deflector wall 10 with the second flow-through region 13 by the center web 11, the operating principle can be improved, particularly if it is supplemented by further second deflector walls 10a-10c, which are in turn spaced apart from one another by further center webs 11a-11c. It can be seen in FIG. 2 that the individual deflector walls 9, 10, 10a-10c are spaced apart from one another and are each turned against one another in relation to the flow-through regions 12, 13, 13a-13c, so that the deflected media flow 17 through the oil separator housing 5, caused by the labyrinth mechanism 7, results. In other words, multiple stages on the labyrinth mechanism, so-called deflector walls, which have a plate-shaped design in FIG. 2 and have cutouts or flow-through regions 12, 13, 13a-13c at opposite points in each case, are used as the labyrinth and retain oil, oil mist and oil foam.

For axial positioning, the end wall 14 rests against the axial stop 16 of the oil separator housing 5, the radial positioning is achieved by means of the support of the deflector walls 9, 10, 10a-10c. As an alternative to the embodiment shown, the labyrinth mechanism 7 can be pressed, glued or fixed with an undercut in the ventilator mechanism 4. The flow-through regions 12, 13, 13a-13c are small by comparison with those through the respective deflector wall 9, 10, 10a-10c, in any case they are smaller than 40%, and preferably smaller than 20%.

List of reference signs:

| | |
|---|---|
| 1 | Oil separator mechanism |
| 2 | Media inlet |
| 3 | Media outlet |
| 4 | Ventilating mechanism |
| 5 | Oil separator housing |
| 6 | Surrounding environment |
| 7 | Labyrinth mechanism |
| 8 | Ventilation direction |
| 9 | First deflector wall |
| 10 | Second deflector wall |
| 10a-10b | Further second deflector walls |
| 11 | Center web between 9 and 10 |
| 11a-11c | Further center webs |
| 12 | First flow-through region |
| 13 | Second flow-through region |
| 13a-13c | Further second flow-through regions |
| 14 | End wall |
| 15 | Outlet region |
| 16 | End stop of 5 |
| 17 | Media flow deflected by 7 |

1.-5. (canceled)

6. A machine housing ventilator, comprising:
an oil separator mechanism which has a media inlet and a media outlet;
an air-permeable ventilation mechanism, wherein the media outlet is covered by the air-permeable ventilation mechanism or is fluidically connected thereto,
wherein the oil separator mechanism further comprises:
an oil separator housing in which the media inlet is arranged, wherein the media inlet allows a gaseous medium to enter the oil separator housing as intended, and to escape through the media outlet and through the air permeable ventilation mechanism into an environment surrounding the machine housing ventilator; and
a labyrinth ventilator mechanism for deflecting medium flowing through the machine housing ventilator, wherein
an imaginary rectilinear flow direction through the oil separator housing is defined as a ventilation direction from the media inlet to the media outlet, and
the labyrinth ventilator mechanism is surrounded by the oil separator housing,
at least in part, in a circumferential direction, in relation to the ventilation direction, and is configured as a separate component in relation to the oil separator housing.

7. The machine housing ventilator according to claim 6, wherein
the labyrinth ventilator mechanism has a first and at least a second deflector wall, and
the first and the at least second deflector wall are connected to one another via a center web and spaced apart from one another by the web,
the first and the at least second deflector wall are arranged downstream of the media inlet and upstream of the media outlet, in the ventilation direction, in the oil separator housing,
the first deflector wall closes off the oil separator housing except for at least a first flow-through region which can be flowed through, and
the second deflector wall closes off the oil separator housing except for at least a second flow-through region which can be flowed through, and
the first deflector wall constricts an area that can be flowed through in the oil separator housing to 40% or less of a total cross-sectional area of the oil separator housing, relative to the location at which the first deflector wall is arranged, and
the second deflector wall constricts the area that can be flowed through in the oil separator housing to 40% or less of the total cross-sectional area of the oil separator housing, relative to the location at which the second deflector wall is arranged.

8. The machine housing ventilator according to claim 7, wherein
the first and the at least a second deflector wall are arranged in the oil separator housing such that:
the first and the second flow-through regions are offset in relation to one another, so that a rectilinear flow in the ventilation direction through the oil separator housing is prevented by the first and the at least a second deflector wall.

9. The machine housing ventilator according to claim 6, wherein
the labyrinth ventilator mechanism has an end wall which comprises at least an outlet region which can be freely flowed through,
the oil separator housing has a limit stop,
the end wall is in contact with the oil separator housing at the limit stop in an axial direction, and
the at least one outlet region which can be freely flowed through forms the media outlet in the end wall.

10. A motor vehicle gearbox comprising a machine housing ventilator according to claim 6.
